(19) United States
(12) Patent Application Publication
(10) Pub. No.: US 2020/0155985 A1
(43) Pub. Date: May 21, 2020

(54) Filter Medium, Method for Producing Same, and Use of the Filter Medium in a Filter Element

(71) Applicant: MANN+HUMMEL GmbH, Ludwigsburg (DE)

(72) Inventors: Ivanka Poljak, Goeteborg (SE); Till Batt, Stuttgart (DE); Steffen Pfannkuch, Ludwigsburg (DE); Thilo Mueller, Karlsruhe (DE); Anja Koronai, Ludwigsburg (DE)

(21) Appl. No.: 16/691,101

(22) Filed: Nov. 21, 2019

Related U.S. Application Data
(63) Continuation of application No. PCT/EP2018/063590, filed on May 24, 2018.

(30) Foreign Application Priority Data
May 24, 2017 (DE) 102017004973.4

(51) Int. Cl. B01D 39/16; B01D 39/18; B01D 46/52; B32B 5/02; B32B 29/02; B32B 7/14; B32B 37/12; B32B 37/18; B32B 37/06; B32B 37/10

(52) U.S. Cl. CPC B01D 39/163; B32B 2317/12; B01D 46/522; B32B 5/022; B32B 29/02; B32B 7/14; B32B 37/1207; B32B 37/182; B32B 37/06; B32B 37/10; B32B 37/1292; B01D 2239/0681; B01D 2239/0618; B01D 2239/0457; B01D 2239/0464; B01D 2239/065; B01D 2239/1258; B01D 2239/1233; B01D 2239/10; B01D 2275/10; B01D 2279/60; B32B 2037/1215; B32B 2250/02; B32B 2262/0276; B32B 2307/724; B32B 2307/3065; B32B 2367/00; B01D 39/18

(57) ABSTRACT

A filter medium for filtration of a gaseous medium is provided with a carded nonwoven layer and a filter paper layer arranged as a neighboring filter layer at an outflow side of the carded nonwoven layer. The carded nonwoven layer has a first air permeability and the filter paper layer has a second air permeability, wherein the first air permeability of the carded nonwoven layer is higher than the second air permeability of the filter paper layer. In a filter element with such a filter medium, the filter medium is folded to a folded filter medium with folds with a fold spacing of more than 3.5 mm and a fold height of between 10 mm to 60 mm.

### CROSS-REFERENCE TO RELATED APPLICATIONS

This application is a continuation application of international application No. PCT/EP2018/063590, having an international filing date of 24 May 2018 and designating the United States, the international application claiming a priority date of 24 May 2017 based on prior filed German patent application No. 10 2017 004 973.4, the entire contents of the aforesaid international application and the aforesaid German patent application being incorporated herein by reference.

### BACKGROUND OF THE INVENTION

The invention concerns a filter medium, in particular for filtration of a gaseous medium, that comprises a carded nonwoven layer and a filter paper layer arranged at the outflow side thereof. The invention concerns also a method for its production and a use of this filter medium.

Nowadays, primarily filter media based on cellulose fibers, referred to in the following as filter paper, are the conventional standard on the market. In comparison to these media, the use of a filter medium in the meaning of the invention provides significant performance improvement.

For filtration of an air flow, WO 2008/078858 A1 discloses a two-layer or multi-layer filter medium with a spunbond nonwoven layer which is arranged at the inflow side relative to a paper layer. However, this provides no sufficient performance improvement in comparison to filter paper.

### SUMMARY OF THE INVENTION

Based on the aforementioned prior art, it is therefore the object of the present invention to provide a filter medium in which separated dust is distributed uniformly on the filter layer and a good separation efficiency with good air permeability is achieved.

This object is solved by a filter medium comprising a carded nonwoven layer and a filter paper layer arranged at the outflow side thereof as a neighboring filter layer, wherein the carded nonwoven layer comprises a higher air permeability than the filter paper layer.

A filter medium according to the invention comprises a carded nonwoven layer and a filter paper layer arranged at the outflow side thereof as a neighboring filter layer. The carded nonwoven layer has a higher air permeability than the filter paper layer. The carded nonwoven layer in this context is preferably compacted less than the filter paper layer or a spunbond nonwoven layer. Therefore, the dust intake capacity of the filter medium is increased and the pressure loss upon flow of the gaseous medium to be filtered, for example, air, through the filter medium is reduced.

In case of the filtration of dust-laden air, the dust separated in the open-pore carded nonwoven layer can be distributed particularly uniformly.

Due to this deep filtration, for a comparable degree of separation (in the meaning of ISO 5011 in the version at the time of first filing of the present invention), a higher dust intake capacity of the filter medium can be achieved in comparison to conventional single-layer filter papers as well as in comparison to combined conventional filter media, comprised of a single-layer filter paper and a single-layer spunbond layer (melt-blown or spunbond). At the same time, the air permeability of the filter medium according to the invention is greater in comparison to a single-layer paper filter medium with comparable degree of separation.

Further advantageous embodiments of the invention are subject matter of the dependent claims.

The air permeability of the carded nonwoven layer according to DIN EN ISO 9237 at a differential pressure of 200 Pa can amount to more than 8001/m²/s. In an especially preferred embodiment of the invention, the air permeability of the carded nonwoven layer amounts to 1,600 l/m²/s to 6,000 l/m²/s according to the aforementioned measuring conditions. The filter paper layer can advantageously comprise an air permeability of less than 8001/m²/s in accordance with the above-mentioned measuring conditions.

The fibers of the carded nonwoven layer can have an average fiber fineness (in the meaning of ISO 1144 or DIN 60905 in the version at the time of first filing of the present invention) in the range of 1 decitex to 30 decitex. This preferred fiber fineness enables a particularly effective particle separation from a gaseous medium with simultaneous good mechanical properties of the carded nonwoven layer.

In a preferred embodiment, the carded nonwoven may comprise a mixture of at least two fiber types with different fiber fineness. In a preferred embodiment, the carded nonwoven layer has a fine fiber proportion of at least 10% based on mass, comprised of fibers of 0.7-4 decitex fineness, as well as a coarse fiber proportion of at least 10% based on mass, comprised of fibers of 3-10 decitex fineness. In comparison to the use of a combination of a single-layer paper with a spunbond nonwoven (melt-blown or spunbond) (in the meaning of e.g. U.S. Pat. No. 6,315,805), this advantageous combination of the carded nonwoven, in particular due to the achievable fiber fineness and level of crimp as well as their selectability and mixability and the thus adjustable packing density (ratio of density to weight per surface area), provides for a particularly effective particle separation from a gaseous fluid with simultaneous good mechanical properties of the carded nonwoven layer.

The use of a carded nonwoven has in this context the advantage that in case of a carded nonwoven, for example, in comparison to a meltblown, fiber mixtures of fibers of different thickness can be used without process-technological extra expenditure.

The average weight per surface area of the nonwoven carded layer can amount to from 10 g/m5 to 120 g/m5, particularly preferred 35 g/m5 to 100 g/m5. The combination of the aforementioned fiber fineness and of the weight per surface area describes an optimized ratio between filtration performance and sufficient permeability of the filter material. This enables high dust intake capacities of the filter medium according to the invention with simultaneously high air permeability. A corresponding weight per surface area determination can be performed according to DIN EN ISO 9237 in the version at the time of first filing of the present invention.

Packing density is understood in the following as the volume-based solid proportion of the filter medium. The employed carded nonwoven layer is in a range of the packing density between 1% to 10%, preferably in the range of 2% to 7%.

The filter paper layer can be preferably a wet-laid cellulose fiber layer. The cellulose fiber layer in the context of the present invention may contain up to 30 percent by weight of synthetic fibers. The filter paper layer enables, on the one hand, a fine filtration and, in addition, imparts to the filter medium advantageously high mechanical stiffness.

An impregnation can prevent the detachment of the fibers from the filter paper layer and ensures good resistance of the material relative to water and other liquid contact substances. The packing density of the impregnated filter paper layer is preferably greater than 10% and less than 30%. In this way, additionally a desired resistance relative to water (water resistance) and a satisfactory stiffness and processability on rotary folding machines is achieved at the same time. Water resistance in the meaning of this application is measured based on the water absorption capacity according to DIN EN ISO 535 in the version at the time of first filing of the present invention, wherein water-resistant in the meaning of this application means a water absorption capacity according to Cobb60 of DIN EN ISO 535 of below 20 g/m5 at 20° C. and standard pressure.

The filter medium according to the invention can comprise advantageously flame-retardant properties. In this way, the safety when using the filter medium in a series of application situations is additionally increased. For this purpose, the filter paper layer can advantageously comprise a flame-retardant impregnation. The flame retardant agent that is preferably provided or contained in the impregnation can be a phosphorus-based flame retardant agent in a particularly preferred embodiment variant.

The concentration and the type of the flame retardant agent is preferably to be selected such that the filter paper layer has flame-retarding properties according to the flammability rating F1 according to DIN 53 438-3), in the version at the time of first filing of the present invention.

In a preferred embodiment, in particular suitable for air filtration of internal combustion engines, at least 80% of the fibers in the carded nonwoven layer contain polyester. In this context, polyester fibers as well as polyester copolymer fibers may be provided. These materials are advantageous because they are particularly heat-resistant. The polyester copolymer fibers can comprise in particular a core/sheath structure, e.g. with conventional polyester materials as core enveloped by an envelope (sheath) of polyester copolymer. When producing the carded nonwoven layer, mechanical and thermal reinforcement methods such as needling and thermofusion can be used.

The fibers of the carded nonwoven layer, in particular the polyester-containing fibers, can be reinforced with each other advantageously mechanically, e.g., under the action of pressure and/or thermally. This can be advantageously done by lamination of the layers, preferably under the action of pressure and heat, in particular by thermo/pressure calandering. A further preferred embodiment variant for the alternative or additional connection of two layers is ultrasound welding.

Alternatively or additionally, both filter layers, i.e., the carded nonwoven layer and the filter paper layer, can also be glued together. The connection in this variant is then realized advantageously by means of an adhesive middle layer, for example, suitable adhesive layers are hot-melt adhesives (hot-melt adhesives) or reactive polyurethane adhesives.

The invention comprises in addition a filter element with a folded filter medium according to the invention. The filter medium is foldable and can therefore be further processed to a folded bellows. The folds of the filter element, in particular of the folded bellows, can comprise advantageously fold spacings of more than 3.5 mm, in particular 4 mm to 8 mm. The fold height of the filter medium amounts to between 10 mm and 60 mm. The fold distance of a folded bellows of conventional filter paper amounts to usually 3.5 mm or less.

The folds of the filter medium can have end face edges. They are arranged at the ends of the folds. Alternatively or in addition to the aforementioned lamination methods, carded nonwoven layer and paper layer can be connected when manufacturing the filter bellows. For this purpose, the glue/adhesive layer which is applied in conventional filter elements for sealing the end face edges can be employed.

The invention comprises in addition a method for producing a filter element according to the invention with the following steps:
I providing a carded nonwoven layer, in particular for filtration of a gaseous medium;
II providing a filter paper layer arranged at the outflow side relative to the carded nonwoven layer as a neighboring filter layer, wherein the filter paper layer has a reduced air permeability in comparison to the carded nonwoven layer;
III connecting at least the carded nonwoven layer and the filter paper layer to a filter medium; and
IV providing a filter element with the filter medium, wherein providing comprises at least deforming the filter medium, preferably at least folding of the filter medium to a folded bellows.

Connecting the filter paper layer with the carded nonwoven layer can also be realized during the production of the folded bellows. In this context, advantageously the adhesive traces or adhesive beads which are provided for sealing and stabilizing the folded bellows can be used which, prior to erecting the folds, are applied to one of the two filter layers.

An advantageous use of the filter medium according to the invention and/or of the filter element according to the invention concerns the filtration of air. Particularly preferred is the use for filtration of the intake air of internal combustion engines.

Due to the aforementioned increased fold spacing compared to conventional paper filter elements, a filter element of the filter medium according to the invention, with a smaller filter surface area compared to a conventional element of filter paper, advantageously comprises in addition better performance data compared to the conventional element of filter paper when used in the air filtration, in particular when tested according to ISO 5011.

### BRIEF DESCRIPTION OF THE DRAWINGS

In the following, the invention will be explained in more detail with the aid of embodiments and with the aid of Figures. The embodiments are only to be understood in an exemplary fashion and are in no way limiting in regard to the subject matter of the invention.

FIG. 1 is a schematic illustration of a filter medium according to the invention, comprised of a carded nonwoven layer and a filter paper layer.

FIG. 2 is a lateral view of a folded filter medium according to the invention.

FIGS. 3a to 3c are schematic illustrations of a filter medium according to the invention, comprised of a carded nonwoven layer and a filter paper layer which are connected to each other by different lamination types.

FIG. 4 is a graphic illustration of the pressure drop relative to the dust intake capacity of the filter medium in comparison to a comparative filter medium.

### DESCRIPTION OF PREFERRED EMBODIMENTS

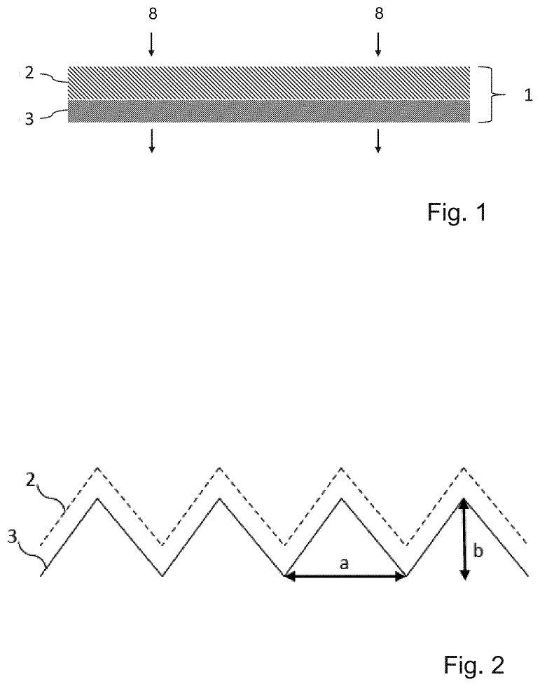

FIGS. 1 and 2 show an embodiment of a filter medium 1 according to the invention with a nonwoven layer of synthetic fibers, formed in the form of a carded nonwoven layer 2, arranged at the inflow side and a filter paper layer 3 arranged at the outflow side, for example, an impregnated filter paper layer.

The fibers of the filter paper layer 3 are arranged more closely to each other and thus have a higher degree of separation than the fibers of the carded nonwoven layer 2.

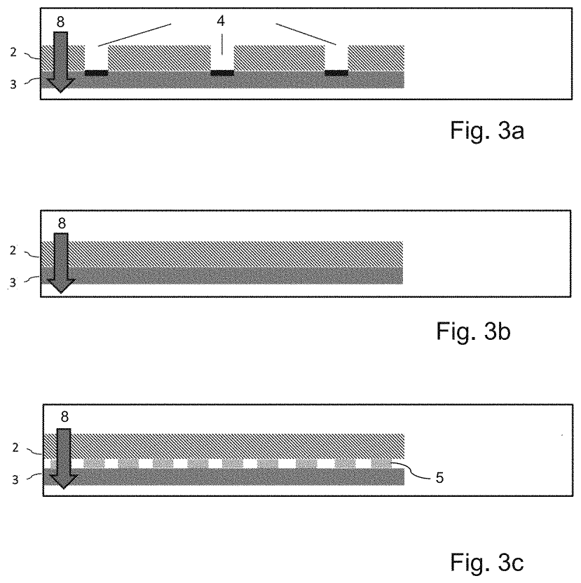

The filter paper layer 3 arranged at the outflow side is water-resistant (measured based on the water absorption capacity according to DIN EN ISO 535 wherein water-resistant in the meaning of this application is a water absorption capacity according to Cobb60 of DIN EN ISO 535 below 20 g/m5 at 20° C. and standard pressure) and preferably furnished to be flame-retardant. The flow direction 8 is illustrated in FIGS. 1 and 3a to 3c by arrows.

The cellulose fibers are preferably wet-laid when producing the filter paper layer 3.

The carded nonwoven layer 2 can be formed to at least 80 percent by weight (wt. %) of polyester. This fiber type has been found to be in particular heat-resistant and is therefore preferred. The remaining 20 wt. % of such fiber types can be, for example, bi-component fibers with a polyester core and a co-polyester sheath.

The fineness of the fibers of the carded nonwoven layer 2 amounts to between 1 decitex to 30 decitex, preferably 3 decitex to 15 decitex.

The average fiber diameter of the fibers of the carded nonwoven layer can preferably be greater than 10 Om. The air permeability of the carded nonwoven layer 2 amounts to preferably 1,600 l/(m²*s) to 6,000 l/(m²*s) at a pressure difference of 200 Pa in accordance with EN ISO 9237. The employed measuring device must correspond to the specifications of the above-mentioned standard.

In a particularly preferred variant, the carded nonwoven layer 2 can be comprised of fibers of a polyester or comprise more than 80 percent by weight of such fibers. In a further preferred variant, at least 10 percent by weight of the fibers of the carded nonwoven layer 2 can be comprised of bi-component fibers or so-called core-sheath fibers which contain proportions of a polyester copolymer. In this context, preferably the core material can be comprised of a pure polyester material and the sheath fibers of a polyester copolymer, in particular of a co-polyester with reduced melting temperature compared to polyester.

Alternatively or in addition to a polyester material, also polypropylene as a fiber material can be used for the fibers of the carded nonwoven layer 2. The average fiber length of the fibers of the carded nonwoven layer 2 can amount to between, for example, 20 mm to 100 mm, preferably between 50 mm and 60 mm.

For use in a filter element, not illustrated in detail, the filter medium is folded to a so-called folded bellows which is illustrated in sections in FIG. 2. A corresponding filter element with a filter medium embodied as a folded bellows is disclosed, for example, in DE 10 2012 25 019 862 A1.

The fold spacing (a) of the folded filter medium 1 can amount to preferably more than 3.5 mm, particularly preferred between 4 mm to 8 mm.

The fold height (b) of the folded filter medium 1 can be preferably between 10 mm to 60 mm.

In accordance with FIGS. 3a to 3c, the layers of the filter medium can be connected to each other by lamination. In this context, the connection between the layers 2 and 3 is produced by an adhesive 5, for example. The latter can be provided preferably in the form of an adhesive layer (nonwoven) or an adhesive powder or can be embodied as a spray-on application as an interrupted film. The connection by means of adhesive is illustrated in FIG. 3c.

Alternative types of lamination are provided by thermofusion or thermo-calandering, i.e., a connection of the layers by means of heat and/or by increased pressure. This is illustrated in FIG. 3b. A further optional possibility resides in a local (interrupted) connection of the layers by ultrasound welding. This is illustrated in FIG. 3a in which the filter medium comprises weld spots 4 which are introduced, for example, by ultrasound welding or thermo-calandering into the filter material. Of course, individual methods or method steps, which are illustrated in FIGS. 3a to 3c, can also be combined with each other.

A further optional connection possibility is available in the production of folded bellows from the filter medium. For this purpose, the layers 2 and 3 are supplied separately to a folding machine. The connection of the layers can then be preferably realized by the end face edge gluing of the folded bellows, i.e., an adhesive trace which is applied along the end face edges and holds together the folds and effects a separation between raw and clean side in the region of the fold pockets or of the end faces that are formed by the end face edges extending in a zigzag shape. In addition, in case of the loose layers in the process, adhesive traces but also adhesive beads applied prior to the folding process can ensure the cohesion of the layers.

The filter medium 1 comprises preferably maximally three filter layers, i.e., a further filter layer in addition to the carded nonwoven layer 2 and the filter paper layer 3. One or two optional adhesive layers which connect the three filter layers to each other can also be provided. The arrangement of maximally three filter layers promotes an inexpensive manufacture by means of a process-reliable stable foldability of the filter medium. In this context, the filter paper layer 3 is always a filter layer neighboring the carded nonwoven layer 2.

However, in the context of the present invention, it is possible that two carded nonwoven layers of different fineness are provided wherein a first one of these two layers is the carded nonwoven layer 2 and the second carded nonwoven layer arranged above is arranged at the inflow side relative to the carded nonwoven layer 2. It is also possible in the context of the present invention that the filter paper layer 3 comprises a gradient in regard to the fiber density and/or the average fiber diameter in flow-through direction, which is indicated in FIG. 1 by an arrow. Preferably, in this context the outflow side of the filter medium is more strongly compacted and is comprised on average of finer fibers than the inflow side.

For additional increase of the mechanical strength and stiffness, individual filter layers can be needled, impregnated or thermally bonded.

The filter medium 1 according to the invention is used preferably in air filter elements. A particularly preferred application in this context is the filtration of intake air of internal combustion engines required for combustion, for example, of motor vehicles and motorcycles.

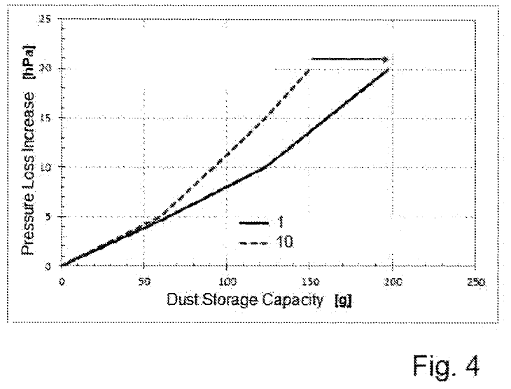

The diagram illustrated in FIG. 4 illustrates the increase of the dust intake capacity or dust storage capacity of a filter element comprised of folded filter medium of the filter medium 1 according to the invention in comparison to a conventional paper element (single-layer cellulose paper) whose folds are produced only of filter paper. This was contrasted with an increasing pressure drop.

Relative to this comparative medium, the use of a filter medium in the meaning of the invention provides significant performance improvement. The dust intake capacity of the filter element 1 according to the invention for the same degree of separation relative to the dust capacity of the single-layer cellulose paper is significantly increased (see Table 1). By connecting the two aforementioned layers, an optimization of the filtration performance (dust intake capacity and/or separation degree) is realized. The increase of the dust intake capacity materializes over the course of a continuous dust addition and the thus induced pressure loss increase of the respective filter element 1 or 10. This is determined in accordance with the method of ISO 5011 described in the version at the time of first filing of the present invention. A test dust according to ISO 12103-A2 in the version at the time of first filing of the present invention was used. The mass flow of the dust-laden test flow amounted to 750 kg/h. By use of the filter medium according to the invention, material can be saved in comparison to a filter paper of comparable thickness or a combination of filter paper and a spunbond layer. Also, the pressure loss by use of the filter medium according to the invention is significantly reduced, which has further advantages in certain fields of application.

TABLE 1

| | ISO 5011 dust test | | |
|---|---|---|---|
| | air mass flow 750 kg/h | | |
| | test dust ISO 12103-1 A2 | | |
| | final pressure loss increase 20 mbar | | |
| | initial | final | |
| | degree of | degree of | dust |
| | separation | separation | capacity |
| Filter material | [%] | [%] | [g] |
| Single-layer paper medium | 99.2 | 99.6 | 150 |
| (single-layer cellulose paper) | | | |
| Filter medium 1 according to | 99.2 | 99.6 | 197 |
| the invention (carded | | | |
| nonwoven layer 2 and filter | | | |
| paper layer 3 arranged at | | | |
| the outflow side thereof) | | | |

What is claimed is:

1. A filter medium for filtration of a gaseous medium, the filter medium comprising:
a carded nonwoven layer;
a filter paper layer arranged as a neighboring filter layer at an outflow side of the carded nonwoven layer;
the carded nonwoven layer comprising a first air permeability and the filter paper layer comprising a second air permeability, wherein the first air permeability of the carded nonwoven layer is higher than the second air permeability of the filter paper layer.

2. The filter medium according to claim 1, wherein the first air permeability of the carded nonwoven layer, measured according to DIN EN ISO 9237 at a differential pressure of 200 Pa, amounts to more than 800 l/m²/s.

3. The filter medium according to claim 2, wherein the first air permeability of the carded nonwoven layer amounts to 1,600l/m²/s to 6,000l/m²/s.

4. The filter medium according to claim 1, wherein the second air permeability of the filter paper layer, measured according to DIN EN ISO 9237 at a differential pressure of 200 Pa, is less than 800 l/m²/s.

5. The filter medium according to claim 1, wherein the carded nonwoven layer comprises fibers of an average fineness in a range of 1 decitex to 30 decitex.

6. The filter medium according to claim 1, wherein the average weight per surface area of the carded nonwoven layer, measured according to DIN EN 29073-1, amounts to between 10 g/m² to 120 g/m².

7. The filter medium according to claim 1, wherein the filter paper layer comprises a wet-laid cellulose fiber layer.

8. The filter medium according to claim 7, wherein the wet-laid cellulose fiber layer comprises up to 30 percent by weight of synthetic fibers.

9. The filter medium according to claim 1, wherein the filter paper layer and/or the carded nonwoven layer comprises an impregnation.

10. The filter medium according to claim 9, wherein the filter paper layer comprises cellulose fibers and wherein the impregnation strengthens and bonds the cellulose fibers.

11. The filter medium according to claim 9, wherein the impregnation is a flame-retardant impregnation.

12. The filter medium according to claim 11, wherein the flame-retardant impregnation comprises a flame retardant agent.

13. The filter medium according to claim 12, wherein the flame retardant agent is a phosphorus-based flame retardant agent.

14. The filter medium according to claim 12, wherein the flame retardant agent and a concentration of the flame retardant agent are selected such that the filter paper layer and/or the carded nonwoven layer comprises flame-retardant properties according to the flammability rating F1 according to DIN 53 438-3.

15. The filter medium according to claim 12, wherein the flame retardant agent and a concentration of the flame retardant agent are selected such that the filter medium comprises flame-retardant properties according to the flammability rating F1 according to DIN 53 438-3.

16. The filter medium according to claim 1, wherein at least 80 percent by weight of fibers of the carded nonwoven layer contain polyester.

17. The filter medium according to claim 1, wherein the filter paper layer and the carded nonwoven layer are laminated to each other.

18. The filter medium according to claim 17, wherein the filter paper layer and the carded nonwoven layer are laminated to each other by pressure and heat.

19. The filter medium according to claim 18, wherein the filter paper layer and the carded nonwoven layer are laminated to each other by pressure and heat applied by thermo/pressure calandering.

20. The filter medium according to claim 1, wherein the filter paper layer and the carded nonwoven layer are connected to each other.

21. The filter medium according to claim 20, wherein the filter paper layer and the carded nonwoven layer are connected to each other by an adhesive middle layer.

22. A filter element comprising:
a filter medium comprising a carded nonwoven layer; a filter paper layer arranged as a neighboring filter layer at an outflow side of the carded nonwoven layer; the carded nonwoven layer comprising a first air permeability and the filter paper layer comprising a second air permeability, wherein the first air permeability of the carded nonwoven layer is higher than the second air permeability of the filter paper layer;
wherein the filter medium is folded to a folded filter medium comprising folds with a fold spacing of more than 3.5 mm and a fold height of between 10 mm to 60 mm.

23. The filter element according to claim 22, wherein the fold spacing is 4 mm to 8 mm.

24. The filter element according to claim 22, wherein the folds of the folded filter medium comprise end face edges, wherein the carded nonwoven layer and the filter paper layer of the folded filter medium are glued to each other along the end face edges.

25. The filter element according to claim 24, wherein the carded nonwoven layer and the filter paper layer of the folded filter medium are glued to each other by continuous adhesive traces.

26. The filter element according to claim 24, wherein the continuous adhesive traces are comprised of hot melt adhesive.

27. The filter element according to claim 22 configured as an intake air filter of an internal combustion engine.

28. A method for producing a filter element according claim 22, the method comprising:
providing the carded nonwoven layer;
arranging the filter paper layer at the outflow side relative to the carded nonwoven layer as a neighboring filter layer;
connecting the carded nonwoven layer and the filter paper layer to form the filter medium; and
folding the filter medium to the folded filter medium of the filter element.

29. The method according to claim 28, further comprising applying adhesive traces prior to folding the filter medium and connecting folds of the folded filter medium by the adhesive traces during folding to connect the filter paper layer and the carded nonwoven layer to each other.
